(19) United States
(12) Patent Application Publication
(10) Pub. No.: US 2025/0224318 A1
(43) Pub. Date: Jul. 10, 2025

(54) System and Method of Testing and Rating Vibration Propagation and Coefficient of Restitution to Provide a Comparative Compressive Rebound Strength for Baseball Bats

(71) Applicants: Jerry R McKeithan, JR., Arden, NC (US); Vimi McKeithan, Arden, NC (US); Joel McKeithan, Arden, NC (US); Timothy McKeithan, Arden, NC (US); Lydia McKeithan, Arden, NC (US); Aaron McKeithan, Arden, NC (US)

(72) Inventors: Jerry R McKeithan, JR., Arden, NC (US); Vimi McKeithan, Arden, NC (US); Joel McKeithan, Arden, NC (US); Timothy McKeithan, Arden, NC (US); Lydia McKeithan, Arden, NC (US); Aaron McKeithan, Arden, NC (US)

(21) Appl. No.: 19/073,739

(22) Filed: Mar. 7, 2025

Related U.S. Application Data
(60) Provisional application No. 63/619,056, filed on Jan. 9, 2024.

(51) Int. Cl. G01N 3/52; G01N 29/04; G01N 29/24

(52) U.S. Cl. CPC G01N 3/52; G01N 29/045; G01N 29/2437; G01N 2291/0238

(57) ABSTRACT

The technology provides a device that measures an internal structural integrity and surface hardness of baseball bats having a bat clamp that secures the baseball bat at a handle end, a bat support that secures the baseball bat at a barrel end, and a rebound hammer that impacts the baseball bat to determine a coefficient of restitution value. The rebound hammer may indirectly impact the baseball bat through a force dispersing tool. The technology further provides a device that measures vibration propagation within baseball bats, having a bat clamp that secures the baseball bat at a handle end, a vibration sensor provided proximate to the handle end, and a vibration impact tool that impacts the baseball bat to transfer a force thereto.

### CROSS-REFERENCE TO RELATED APPLICATION

This application claims priority to U.S. Provisional Application Ser. No. 63/619,056 filed on Jan. 9, 2024, the complete disclosures of which is incorporated herein by reference in its entirety.

### FIELD OF THE TECHNOLOGY

The present technology broadly relates to measuring an internal structural integrity, surface hardness, and vibration propagation of baseball bats. More specifically, this technology relates to testing and rating coefficient of restitution (COR) values of bat barrels to predict a comparative compressive “rebound” strength and vibration propagation value at a bat handles when an impact force is applied to the bat barrel. Still further, this technology relates to rating COR values of bat barrels to give a comparative compressive “rebound” strength and vibration propagation values at bat handles when an impact force is applied to the bat barrel for game-ready baseball bats.

### BACKGROUND OF THE TECHNOLOGY

Baseball bats include several parts. The barrel or striking surface may extend for approximately one-third the length of the bat and may include a selected diameter. The bat barrel tapers down to a narrow handle that is gripped by a batter. The handle terminates in a small swelling called a knob, which helps prevent the bat from slipping out of the batter's hand during a swing. Most batters grip bats so the knob touches the bottom of their hand. Other batters wrap the bottom of their hand around the knob.

The barrel includes a sweet spot that is a preferred hitting area for contacting a baseball. Wooden baseball bats have a lengthwise axis along a longitudinal direction. The wood grain is positioned parallel to the lengthwise axis, creating four distinct quadrants defined along a circumferential direction, two “face grain” quadrants and two “edge grain” quadrants. Typically, for ash bats made of ring bar wood, bat manufacturers apply a logo to the face grain quadrant surfaces. In contrast, for maple or birch bats made of diffuse core wood, bat manufacturers apply a logo to the edge grain quadrant surfaces. The logo is generally positioned somewhere between the barrel sweet spot and the handle area. Bats normally break when striking a baseball off the sweet spot, such as closer to the handle or closer to a barrel end.

Batters typically grip and rotate ash wood bats about the lengthwise axis, so the grain is positioned parallel to a plane defined by a swinging motion of the bat. Ash bats are oriented so the impact surface corresponds to one of the “edge grain” quadrants of the bat, as opposed to the “face grain” quadrants of the bat. For ash wood bats, this orientation reduces a tendency of the wood to splinter and separate between the grain lines due to repeated impacts with the baseball. Alternatively, batters typically grip and rotate maple or birch wood bats in different radial orientations based on individual batter preference. Maple and Birch bats typically break completely into pieces when striking a baseball outside the sweet spot, rather than separating along the grain like ash wood bats.

### BRIEF DESCRIPTION OF THE FIGURES

The technology can be more fully understood by reading the following detailed description together with the accompanying drawings, in which like reference indicators are used to designate like elements. The drawings illustrate several examples of the technology. It should be understood, however, that the technology is not limited to the precise arrangements and configurations shown. In the drawings:

FIG. 1A illustrates a rebound hammer ready to test a material according to one example of the technology;

FIG. 1B illustrates the rebound hammer being pushed toward the material under test according to one example of the technology;

FIG. 1C illustrates the internal mass being released according to one example of the technology;

FIG. 1D illustrates the internal mass rebounding according to one example of the technology;

FIG. 2A illustrates a front perspective view of a device having various tools that record or perform operations on baseball bats according to one example of the technology;

FIG. 2B illustrates a rear perspective view of a device configured for a coefficient of restitution (COR) test according to one example of the technology;

FIG. 2C illustrates a rear perspective view of a device configured for a vibration test according to one example of the technology;

FIG. 3 illustrates a cross-sectional view of the device taken along line III-III of FIGS. 2B and 2C according to one example of the technology;

FIG. 4 illustrates a cross-sectional view of a force dispersion tool taken along line IV-IV of FIGS. 2B and 2C according to one example of the technology;

FIG. 5 illustrates a side perspective view of a force dispersing tool according to one example of the technology;

FIG. 6 illustrates a rear perspective view of the force dispersing tool according to one example of the technology;

FIG. 7 illustrates characteristics of different wooden bats;

FIG. 8 illustrates a flow chart of a process for performing a coefficient of restitution value test according to one example of the technology; and

FIG. 9 illustrates a flow chart of a process for performing vibration testing according to one example of the technology.

### DETAILED DESCRIPTION OF THE TECHNOLOGY

It will be readily understood by persons skilled in the art that the present disclosure has broad utility and application. In addition to the specific examples described herein, one of ordinary skill in the art will appreciate that this disclosure supports various adaptations, variations, modifications, and equivalent arrangements.

It will be appreciated that for simplicity and clarity of illustration, where appropriate, reference numerals may be repeated among the different figures to indicate corresponding or analogous elements. In addition, numerous specific details are set forth to provide a thorough understanding of the examples described herein. However, it will be understood by those of ordinary skill in the art that the examples described herein may be practiced without these specific details. In other instances, methods, procedures, and components are not described in detail so as not to obscure the related relevant feature being described. Also, the description is not to be considered as limiting the scope of the examples described herein. The drawings are not necessarily drawn to scale and the proportions of certain parts may be exaggerated to better illustrate details and features of the present disclosure. Those skilled in the art with access to the teachings provided herein will recognize additional modifications, applications, and examples within the scope thereof and additional fields in which the technology would be of significant utility.

Unless defined otherwise, technical terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and means either, any, several, or all of the listed items. The terms “comprising,” “including,” and “having” are used interchangeably in this disclosure. The terms “comprising,” “including,” and “having” mean to include, but are not necessarily limited to the things so described. The terms “connected” and “coupled” can be such that the objects are permanently connected or releasably connected. The term “substantially” is defined to be essentially conforming to the thing that it “substantially” modifies, such that the thing need not be exact. For example, substantially 2 inches (2″) means that the dimension may include a slight variation.

Baseball bats are manufactured from wood billets that are shaped to comply with league requirements. For example, wood billets typically include maple, birch, or ash billets that are shaped to include an overall length, a knob provided at a first end proximate to a grip area, a barrel, and a barrel end provided at a second end that is opposite to the first end. Wood is an organic material having unique internal grain structure. Accordingly, the characteristics of wood samples obtained from two different trees may be different. Similarly, the characteristics of wood samples obtained from two different portions of a same tree may be different. It follows that the characteristics of two wooden billets, either obtained from a same tree or different trees, may be different. Thus, a same bat model produced from two different billets may have different structural properties. Billet density may be measured to account and quantify the different structural properties of wood. Furthermore, empirical data may be employed to determine whether a specific billet is within specifications to produce a desired bat model.

League rules allow different bat models to include different shapes and physical dimensions. The different bat models accommodate different hitter preferences for bat length, weight, diameter, finish, or the like. To this end, players may order bats from one or more bat manufacturers specifying a model, wood type, cup (yes or no), length, weight, weight distribution (end-loaded vs. handle-loaded), finish, or the like. A professional baseball player typically orders several bats of a same model to ensure availability if any break during a game or practice. For example, professional players may order a dozen bats in one transaction. In contrast to variances in baseball bat characteristics, baseballs are manufactured to tight league tolerances and should all be the same within a same league.

Baseball is a bat-and-ball sport in which players attempt to hit a pitched baseball as hard as possible into or over the field of play, away from the opposing team players, in order to traverse bases and score runs. The collision between the bat and ball transfers energy from the moving bat into the pitched baseball, imparting an exit velocity and causing the baseball to change directions. Many factors contribute to the exit velocity such as bat speed; bat mass; pitched ball speed; bat attack angle relative to the pitched ball path; bat location that collides with the ball, the goal being to contact at the sweet spot; bat compressive “rebound” strength; and the like. According to one example, bat compressive “rebound” strength includes bat internal structural integrity and bat surface hardness. A wood bat has more compressive strength than a baseball. Accordingly, a baseball compresses significantly more than the bat during the bat-and-ball collision, which results in some collision energy being absorbed by the bat. However, most of the collision energy is transferred to the baseball. The higher the compressive “rebound” strength of the bat, the more collision energy is transferred to the baseball, as opposed to being absorbed by the bat. The more collision energy transferred to the baseball results in a higher coefficient of restitution (COR) value measurement for the collision. A COR value closer to “1” indicates a more elastic collision, whereas a COR value closer to “0” indicates a more inelastic collision.

According to one example, bat internal structural integrity is determined by the wood characteristics. In contrast, bat surface hardness is determined by the surface finish. Compressive strength for different materials is commonly measured in units of newtons per square millimeter (N/mm²) or pounds per square inch (lbs/in²). The overall finished bat compressive “rebound” strength is impacted by the bat manufacturing processes including cutting, rough sanding, boning, filler additive, finish sanding, and paint finishing, among other processes. The technology described herein provides techniques for comparing bat compressive “rebound” strength between different bats, among providing other benefits. Furthermore, the technology described herein provides techniques for comparing bat compressive “rebound” strength along a circumferential direction of the bat barrel such as between different quadrants on a same bat, among providing other benefits. Still further, the technology described herein provides techniques for measuring vibration magnitude propagation through the bat, among providing other benefits. According to one example, the bat barrel includes a sweet spot that is designed to transfer maximum energy to a baseball, while minimizing vibration propagation throughout the bat, including at the handle.

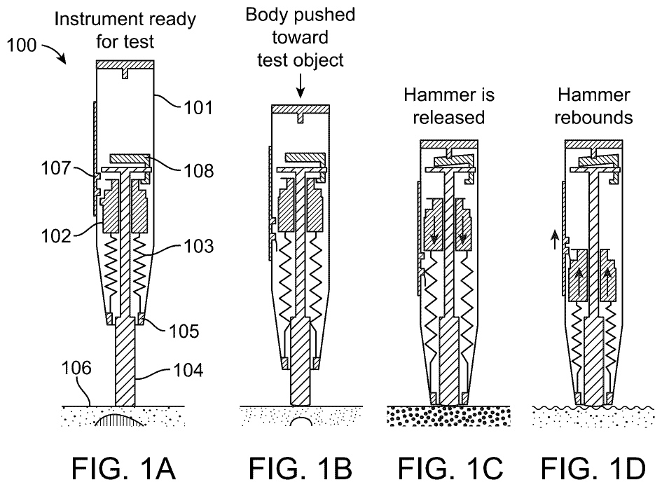

FIGS. 1A-1D illustrate various stages of employing a rebound hammer to measure material compressive strength via a coefficient of restitution. For example, the rebound hammer may be employed to measure a COR value of materials including wood, leather, paper rolls, concrete, rocks, or the like when used in conjunction with empirical charted data. The specific rebound hammer 100 illustrated in FIGS. 1A-1D is a Schmidt rebound hammer having a body 101, internal mass or hammer 102, spring 103, plunger 104, shoulder 105, an indicator 107, and a latch 108, among other components. A rebound hammer 100 operates on the principle of kinetic energy and elasticity. When the hammer 102 strikes the plunger 104, a portion of the energy is absorbed by the material under test, while the remaining energy is reflected back through the plunger 104. The amount of energy that bounces back determines a strength of the underlying material under test. A rebound hammer test is a non-destructive test used to assess the compressive strength and surface hardness of a material under test. According to one example, the plunger 104 is pressed against the material under test 106 in FIGS. 1A-1D. FIG. 1C illustrates the shoulder 105 contacting the material under test 106 while the latch 108 is actuated to release the spring-loaded mass 102 housed within the body 101. According to one example, the spring-loaded mass 102 is propelled by the calibrated spring 103, striking the plunger 104 with a specific energy. FIG. 1D illustrates that the spring-loaded mass 102 rebounds a distance upward, which is measured on the indicator 107 to provide a rebound number or RS #. According to one example, a scale on the indicator 107 records the RS # that correlates to surface hardness and strength of the underlying material under test.

A rebound hammer test relies on a principle that the rebound of an elastic mass depends on the compressive strength and surface hardness of the material under test. According to one example, the rebound hammer 100 may utilize a spring-loaded internal mass 102, having a defined amount of spring force, that strikes a plunger 104 pressed against the material under test 106. The speed of the internal mass 102 after striking the plunger 104 is compared to the speed of the internal mass 102 before striking the plunger 104. The speed quotient is assigned a unitless number, hereinafter called a rebound strength number or RS #. According to one example, the speed quotient or coefficient of restitution (COR) value is defined as velocity out divided by velocity in. Alternatively, the indicator 107 may measure a rebound distance of the mass after impact, which correlates to surface hardness and strength of the underlying material under test. According to one example, the RS # correlates to the compressive “rebound” strength of a material under test. A larger RS # corresponds to a higher compressive “rebound” strength of the material under test. When measuring material compressive strength of a baseball bat via the COR value, the RS # recorded by the hammer depends on the material surface hardness and the internal structural properties of the finished bat.

According to one example, the rebound hammer 100 may be calibrated against a known material. With reference to FIG. 1C and after calibration, a spring release mechanism 108 is actuated to activate a hammer or internal mass 102 that impacts a plunger 104 that is driven against the plunger 104 directly contacting a surface of the material under test 106. With reference to FIG. 1D, after impact, the internal mass 102 bounces off the end of the plunger 104 and the mass exit velocity is recorded and compared to the mass incoming velocity to calculate a RS #. The compressive “rebound” strength rating includes multiple aspects of the tested material such as internal structural integrity and surface hardness, among other aspects. As applied to a baseball bat, the coefficient of restitution (COR) value measures a rebound efficiency at a tested spot, which correlates to the rebound efficiency of a baseball hit off the tested spot during an impact collision.

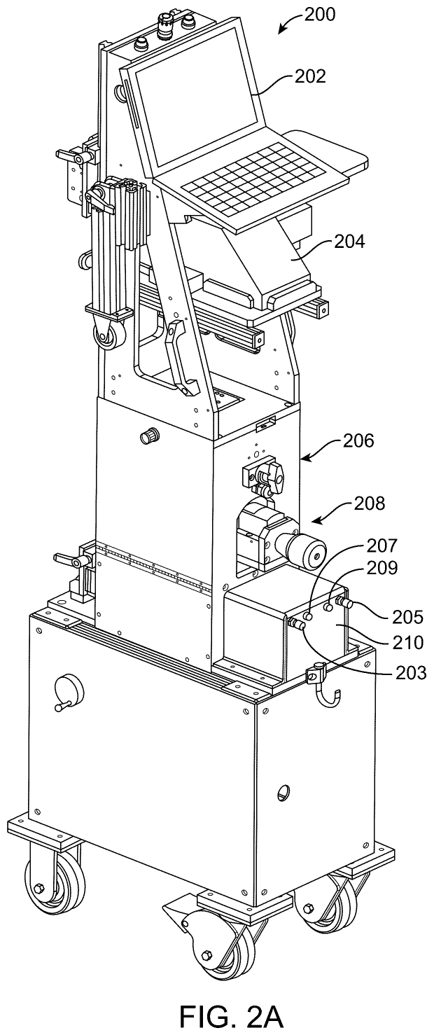

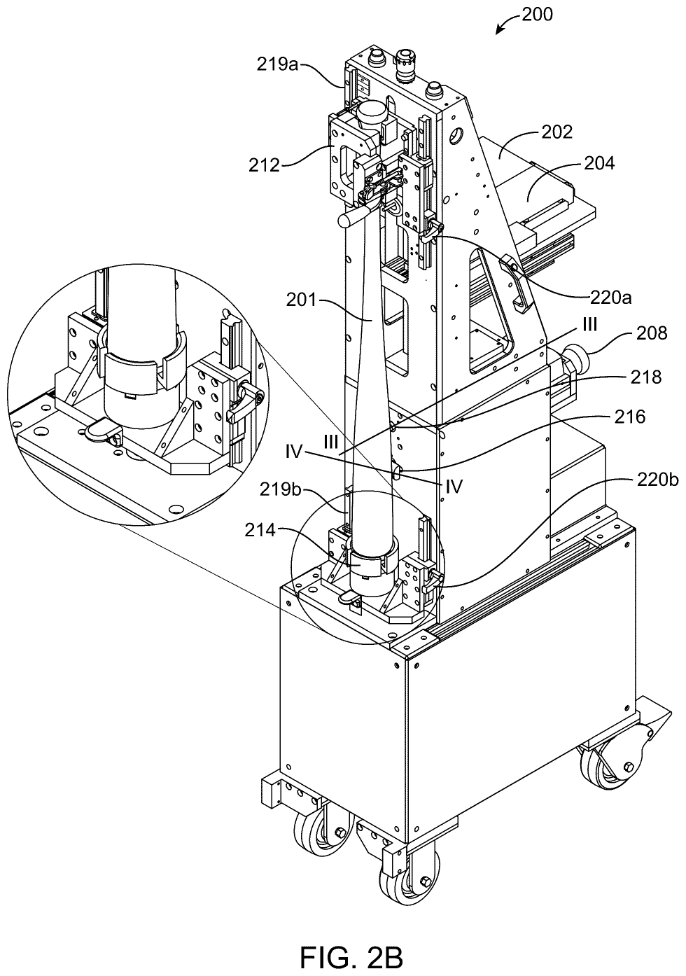

With reference to FIG. 3, the rebound hammer 208 may be mechanically coupled to a hammer actuator 310. For example, the hammer actuator 310 may include an electric actuator that reciprocates forward and backward. According to one example, the hammer actuator 310 may be electrically coupled to the programmable logic controller (PLC, not shown). According to one example, the PLC may generate electrical signals that control a direction, speed, and displacement amount of the hammer actuator 310, among other features. With reference to FIG. 2A, an operator may depress button 203 to activate the hammer actuator 310. During activation, a green light 203 may illuminate. Alternatively, an operator may depress button 205 to deactivate the hammer actuator 310. During deactivation, a red light 203 may illuminate.

Returning to FIG. 3, the rebound hammer 208 may be mounted in a saddle 311 coupled to a linear slide 312. According to one example, the saddle 311 may be oriented to align the plunger 313 of the rebound hammer 208 with the force dispersing tool 216. For example, the plunger 313 may be oriented to contact a guide rod 314 of the force dispersing tool 216. According to one example, the saddle 311 may be oriented so the plunger 313 of the rebound hammer 208 is substantially parallel, relative to a top surface of the linear slide 312. According to one example, a second member 315 may be provided to mechanically couple the hammer actuator 310 and the linear slide 312. According to one example, a handle 317 may be provided at the saddle 311 to allow for manual actuation of the rebound hammer 208. For example, manual actuation could be employed if the hammer actuator 310, the PLC, or other component cease to function.

According to one example, the rebound hammer 208 may include any commercially accepted and available rebound hammer used to measure coefficient of restitution. According to one example, the coefficient of restitution value is employed to determine a compressive strength of a tested material. For example, the rebound hammer 208 may be a commercially available Paper Schmidt PS8000, manufactured by Proceq AG. According to one example, the Paper Schmidt PS8000 provides an impact energy of 0.735 Nm through the plunger.

FIG. 2A illustrates a front perspective view of a device 200 having various implements or tools that record or perform various operations on baseball bats according to examples of the technology. According to one example, the device 200 may include a computer 202, a printer 204, a vibration impact device 206, a rebound hammer 208, and a control panel 210 having the PLC. According to one example, the control panel 210 may include buttons 203,205, and lights 207,209, among other components. According to another example, the rebound hammer 208 may test the COR (coefficient of restitution) value of the bat 201. According to one example, the vibration impact device 206 may be used to impact the bat 201 in order to create vibrations that are measured at the bat handle through a vibration sensor 225 illustrated in FIG. 2C. According to one example, the computer 202 captures data obtained from the vibration sensor 225 and the rebound hammer 208. The computer 202 may transmit the captured data to the printer 204 to create labels or the like.

FIG. 2B illustrates a rear perspective view of the device 200 configured for coefficient of restitution (COR) value testing according to one example of the technology. According to one example, the device 200 may include various implements or tools that record or perform various operations on baseball bats 201. According to one example, the device 200 may include a bat clamp 212, a bat support 214, a force dispersing tool 216, a rebound hammer 208, a vibration impact tool 218, and a vibration sensor 225, among other components. According to one example, the bat clamp 212 may secure the bat 201 at the handle end. According to one example, the bat support 214 may secure the bat 201 at the barrel end. For example, the bat support 214 may include a multi-jaw clamp or lathe chuck that secures the bat 201 at a barrel end. According to one example, the lathe chuck tool secures the bat 201 to the device 200 via a clamping force, while allowing the bat 201 to rotate about its central or lengthwise axis. According to one example, a chuck key may be employed to loosen or tighten the chuck clamp to modify a bite force on the bat 201. According to one example, the lathe chuck has jaws that are adjustable to receive bats 201 of different diameters therein. According to one example, the lathe chuck may include a different number of jaws. For example, a 3-jaw clamp may be employed to quickly center the bat 201, while a 4-jaw clamp may be employed to hold large or small bats 201. The jaws of a 4-clamp lathe chuck may be loosened so the far edges brace a material from the inside or tightened to hold a small piece of material between an inner gripping surface. One of ordinary skill in the art will readily appreciate that a lathe chuck may include a greater number of jaws such as a six-jaw clamp.

According to one example, the bat support 214 may be coupled to a motor (not shown) that spins or rotates the bat 201 along a circumferential direction under instructions of the control panel 210. According to one example, the motor and bat support 214 may spin the bat 201 in a circumferential direction about its lengthwise axis. For example, the motor and bat support 214 may spin the bat 201 in a circumferential direction up to 360°. Still further, the motor and bat support 214 may spin the bat 201 in a circumferential direction according to pre-determined increments. For example, the motor and bat support 214 may spin the bat 201 in a circumferential direction through 360° in increments such as 1°, 5°, 10°, 15°, 30°, 45°, 60°, 90° or the like. According to one example, the control panel 210 may generate computer program instructions that drive the motor coupled to the bat support 214 to automatically spin the bat 201 according to the desired pre-determined increments. According to one example, the bat clamp 212 may include bearings that facilitate bat rotation. According to another example, the bat clamp 212 may be associated with a motor that spins the bat 201. According to one example, the control panel 210 may generate computer program instructions to select and spin one of the motors associated with the bat clamp 212 or the bat support 214.

According to one example, the bat clamp 212 and the bat support 214 may be employed to secure the bat 201 at two locations for the COR value test. For example, the bat clamp 212 and the bat support 214 may secure the bat 201 at both the handle end and the barrel end. According to one example, securing the bat 201 at two locations for the COR value test enables the rebound hammer to accurately determine the rebound strength. In contrast, a bat 201 secured at only one point may flex or pivot during the COR value test, thereby providing inaccurate rebound strength results. According to one example, the bat clamp 212 and the bat support 214 may slide on corresponding linear bearings 219a,219b to vertically position the bat 201 relative to the rebound hammer 208 and the corresponding force dispersing tool 216. According to one example, the linear bearings 219a,219b (hereinafter 219a,b) may include corresponding lock mechanisms 220a,220b (hereinafter 220a,b) that may be engaged to restrict movement of the bat clamp 212 and the bat support 214, respectively. Alternatively, the lock mechanisms 220a,b may be disengaged to allow movement of the bat clamp 212 and the bat support 214 in vertical directions relative to the device 200. In this way, the linear bearings provide vertical positioning of the bat 201 relative to the rebound hammer 208 and the corresponding force dispersing tool 216. According to one example, the linear bearings 219a,b and the lock mechanisms 220a,b may be positioned to securely engage the bat 201 at the handle end and the barrel end for the coefficient of restitution (COR) value test. According to one example, the bat clamp 212 may include bearings that enable the bat 201 to spin or rotate about its lengthwise axis in a circumferential direction for the COR value test. Accordingly, the COR value test may be performed at any location along a surface of the bat 201.

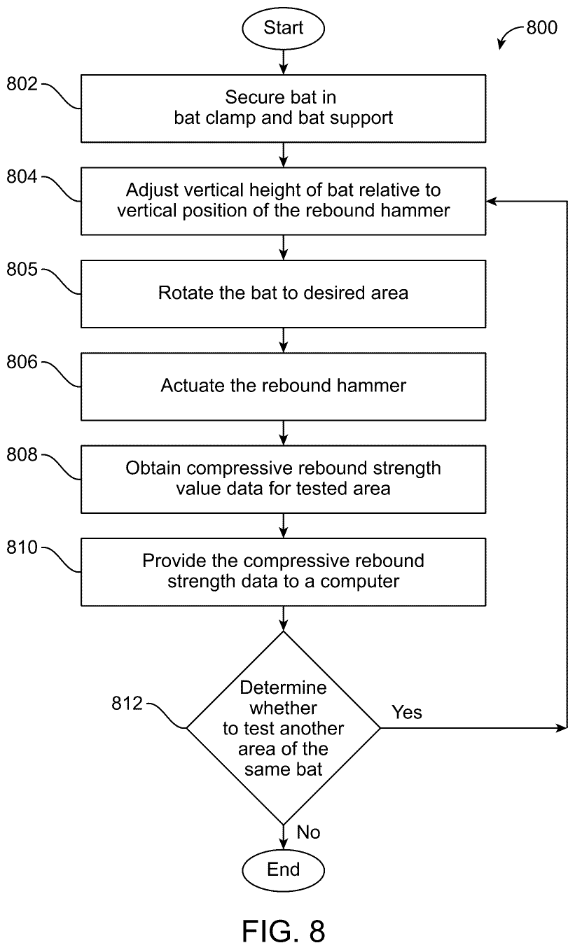

FIG. 8 illustrates a method 800 of performing the COR value test according to one example of the technology. In operation 802, the bat 201 may be fixedly secured within the bat clamp 212 and the bat support 214 at the start of the COR value test. Next, in operation 804, a vertical height or position of a desired location on the bat 201 may be adjusted relative to the vertical position of the rebound hammer 208 and the force dispersing tool 216. According to one example, the bat height may be adjusted by releasing the corresponding lock mechanisms 220a,b and sliding the bat clamp 212 and the bat support 214 to desired vertical positions. For example, the bat clamp 212 and the bat support 214 may be vertically adjusted so the rebound hammer 208 or the force dispersing tool 216 align with the desired location on the bat 201, proximate to the barrel end. With the bat 201 in a desired vertical position, the corresponding lock mechanisms 220a,b may be engaged to lock the bat clamp 212 and the bat support 214 in place to prevent further vertical movement. Next, in operation 805, the bat 201 may be rotated to position the force dispensing tool 216 over a desired barrel location such as the sweet spot or other desired location of the bat 201. In operation 806, the rebound hammer 208 is actuated and, in operation 808, the compressive rebound strength (RS #) value date is obtained for the desired test area of the bat 201. According to one example, the button 203 may be depressed to activate the control panel 210, which actuates the hammer actuator 310 and turns on green light 207. According to one example, the hammer actuator 310 may laterally displace the linear slide 312 via the second member 315 to push the rebound hammer 208, with the corresponding plunger 313, against the force dispersing tool 216. With the bat 201 rigidly held in place by the bat clamp 212 and the bat support 214, the rebound hammer 208 determines an RS # for the tested area of the bat 201. According to one example, the RS # may be a unitless value. According to one example, data corresponding to the RS # may be obtained by or entered into the computer 202 in operation 810.

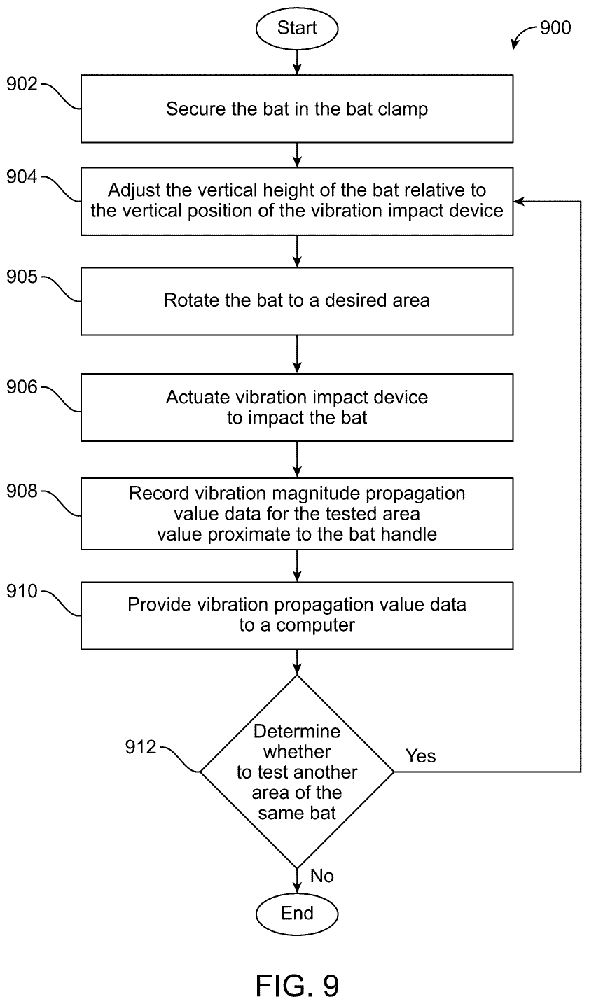

According to one example, the control panel 210 may actuate the hammer actuator 310 to laterally displace the linear slide 312 via the second member 315 to pull the rebound hammer 208 and corresponding plunger 313 away from the force dispersing tool 216. In operation 812, a determination is made regarding whether to test another area of the same bat 201. If yes, the process may repeat operations 804-810. According to one example, returning to operation 804 may include adjusting a height of the bat 201 relative to the vertical position of the rebound hammer 208 and the force dispersing tool 216 and spinning or rotating the bat 201 about its lengthwise axis to the desired location. If no, method 800 ends and the device 200 may proceed to method 900, described below and illustrated in FIG. 9 to perform vibration testing according to one example of the technology.

According to one example, the RS # data obtained from the COR value test may be analyzed to determine minimum and maximum values, an average or mean value, a value range, a standard deviation, or the like. According to one example, the computer 202 may run an algorithm that applies a coefficient of variation (standard deviation divided by mean) to determine if the RS # values are acceptable. If acceptable, the computer 202 may communicate with the printer 204 to print a label with a representative RS #, mean value, last or maximum value, or the like. According to one example, the RS # may be printed on a label and affixed to the corresponding bat 201. According to one example, a same device 200 may be employed to test every bat in a selected batch so that any losses attributed to the force dispersing tool 216 or other components may be consistent from bat to bat. According to one example, the control panel 210 may be programmed to cause the hammer actuator 310 to cycle the rebound hammer 208 through a plurality of actuations. According to one example, the computer 202 mayo record the RS # values corresponding to one or more quadrants of the bat 201. According to another example, the bat 201 may be rotated about its lengthwise axis and the bat height in the device 200 may adjusted relative to the vertical position of the rebound hammer 208 and the force dispersing tool 216 to record RS # values at any position around the circumference of the bat 201.

According to one example, the RS # or coefficient of restitution (COR) value measurement represents a relative compressive “rebound” strength of the bat 201 at a time the test is administered. According to one example, the RS # may be compared to the compressive “rebound” strength of other bats. According to another example, the RS # may be compared to the compressive “rebound” strength of other quadrants on a same bat 201. According to one example, the RS # may change over time as the bat 201 is used to hit baseballs and becomes slightly compressed therefrom. In the case, the RS # may test higher after further compression from using the bat 201. Alternatively, the RS # may test lower over time if the bat material breaks down or degrades with use. For example, a bat 201 may degrade if used to hit baseballs outside of the preferred face grain area or edge grain area. Ideally, the device 200 may be employed to test bats 201 during game conditions or close to a time of intended use to determine the relative compressive “rebound” strength. According to one example, several bats may be tested upon receipt of the bats (e.g., a quantity of 12 bats) to determine which bats of a same model have superior RS #s. According to another example, the bats 201 may be tested to determine one or more barrel quadrants having superior RS #s. Accordingly, the RS # data may inform hitters how much to rotate the bat 201 before gripping the bat handle to hit baseballs with a preferred barrel face having a superior RS #. In other words, the RS # data may inform hitters of a location of the desired bat impact surface to hit baseballs. According to one example, hitters may rotate the bat 201 in a circumferential direction about its lengthwise axis to hit baseballs with a desired bat impact surface. According to one example, the RS # data may inform hitters how to prioritize bat selection from a plurality of available bats. For example, the RS # may inform hitters which bat from a plurality of bats is best to use first during competitive game conditions. Still further, the RS # data may inform hitters of how much to rotate the bat prior to gripping the handle to hit baseballs with the preferred bat impact surface. According to one example, bats that test at the lower end of a group for compressive “rebound” strength may be employed as practice bats. According to one example, a slight increase in RS # from one bat compared to another bat or from one quadrant compared to another quadrant of a same bat may result in a significant increase in baseball exit velocity. According to one example, the technology described herein may serve as a “quality control” system for wooden baseball bats.

FIG. 2C illustrates a rear perspective view of the device 200 discussed with reference to a method 900 illustrated in FIG. 9 for performing vibration testing according to an example of the technology. According to one example, the bat clamp 212 secures the bat 201 at the handle end in operation 902. To the extent method 900 is performed following completion of method 800, then the bat support 214 may be detached from the barrel end of the bat 201 for the vibration test. For example, the bat support 214 and the lock mechanism 220a may be loosened before vertically lifting the bat clamp 212 along the linear bearing 219a prior to starting the vibration test. Accordingly, the bat 201 is secured only at the handle end for the vibration test. Next, in operation 904, a vertical height or position of a desired location on the bat 201 may be adjusted relative to the vertical position of the vibration impact device 206 and the vibration impact tool 218.

Next, in operation 905, the bat 201 may be rotated to position the vibration impact tool 218 over a desired barrel location such as the sweet spot or other desired location of the bat 201. According to one example, the bat clamp 212 may include bearings that enable the bat 201 to rotate in a circumferential direction about its lengthwise axis. In operation 906, the vibration impact device 206 is actuated and, in operation 908, the vibration magnitude propagation value data is obtained for the desired test area of the bat 201. According to one example, data corresponding to the vibration propagation value data may be obtained by or entered into the computer 202 in operation 910. In operation 912, a determination is made regarding whether to test another area of the same bat 201. If yes, the process may repeat operations 904-910. Accordingly, the vibration test may be performed at various locations along the circumference of the bat barrel by rotating the bat 201. For example, the bat 201 may be rotated in selected increments through 360° while vibration testing. According to one example, returning to operation 904 may include adjusting a height of the bat 201 relative to the vertical position of the vibration impact device 206 and the vibration impact tool 218 and spinning or rotating the bat 201 about its lengthwise axis to the desired location. If no, method 900 ends and the device 200 may return to method 800, described above and illustrated in FIG. 8 to perform the COR value test on a different bat 201 according to one example of the technology.

FIG. 3 illustrates a cross-sectional view of the device 200 taken along line III-III of FIG. 2B according to one example of the technology. According to one example, the vibration impact device 206 may be positioned above the rebound hammer 208 within the device 200. Alternatively, the vibration impact device 206 may be positioned below the rebound hammer 208 within the device 200. One of ordinary skill in the art will readily appreciate that the vibration impact device 206 and the rebound hammer 208 may be positioned in other orientations relative to each other. According to one example, the vibration impact device 206 may include a spring mechanism 302 that is mechanically coupled to a rod 304. According to one example, the rod 304 may be mechanically coupled to a vibration impact tool 218 that transfers a force to the bat 201 applied via the spring mechanism 302. According to one example, the vibration impact device 206 may include a handle 306 that is mechanically coupled to a member 307 to engage or disengage the vibration impact tool 218 from contact with the bat 201. For example, the handle 306 may be turned clockwise or counterclockwise to release or engage contact between the vibration impact tool 218 and a surface of the bat 201. According to one example, the spring mechanism 302 may include a calibration nut 308 that adjusts a force applied to the rod 304 via the spring mechanism 302.

According to another example, the vibration impact tool 218 may be implemented using an electric solenoid that converts electrical energy into an electromagnetic force to produce mechanical movement. According to one example, the electric solenoid may include a housing, a wire coil, and a moveable plunger or armature, among other components. According to one example, current flows through the wire coil to generate a magnetic field that may be concentrated by the housing to actuate the plunger. In this way, the electric solenoid converts electrical energy into a magnetic field that mechanically actuates a plunger. According to one example, the rod 304 may be mechanically coupled to a vibration impact tool 218 that transfers a force to the bat 201 applied via the electric solenoid. According to one example, the current flowing through the wire coil may be adjusted to modify a force applied to the rod 304 via the electric solenoid.

With reference to FIG. 2C, the vibration sensor 225 may be mounted proximate to the bat handle end. For example, the vibration sensor 225 may be mounted below the bat clamping device 212 within the bat handle end. According to one example, the vibration sensor 225 may detect mechanical vibrations propagating through the bat 201 following impact by the vibration impact device 206. According to one example, the vibration sensor 225 may include a piezoelectric sensor that employs the piezoelectric effect to measure changes in pressure, acceleration, temperature, strain, or force of a material under test. The piezoelectric sensor may convert the measured changes to an electrical signal for processing by the control panel 210 or the computer 202. According to one example, the vibration sensor 225 may include a piezoelectric accelerometer. According to one example, the vibration sensor 225 may monitor, measure, record, and display a vibration magnitude value detected at a point of interest such as the bat handle.

As discussed above, the bat barrel includes a specific area called a “sweet spot” that provides maximum energy transfer to the baseball from the swinging bat 201, while minimizing vibration propagation to the bat handle. According to one example, the sweet spot is a node or area on the bat barrel where vibrations from impact forces cancel out. According to one example, the vibration sensor 225 may identify a location of the sweet spot by measuring vibrations that propagate through the bat 201 after the bat barrel is impacted. For example, the vibration sensor 225 may be located proximate to the bat handle to measure vibration propagation at the bat handle. Accordingly, the technology may be utilized to minimize vibration sting felt through a hitter's hands when the bat 201 impacts the baseball outside the sweet spot.

For the COR and vibration tests, the bat 201 may be evaluated on four quadrants defined along the circumferential direction based on grain orientation. According to one example, two quadrants may correspond to edge grain area and two quadrants may correspond to face grain area defined along the circumferential direction of the bat barrel. More particularly, two opposing quadrants may correspond to the edge grain area and two opposing quadrants may correspond to face grain area defined along the circumferential direction of the bat barrel.

According to one example, the vibration sensor 225 may be employed to quantify vibration values for any quadrant corresponding to the tested wood types, either ring bar wood for ash bats or diffuse core wood for maple and birch bats. Similarly, the rebound hammer 208 may be employed to quantify COR measurements for any quadrant corresponding to the tested wood types. According to one example, the vibration values and COR measurements may be quantified for the sweet spots located at the two relevant opposing quadrants associated with each wood type. According to another example, the vibration values and COR measurements may be quantified for the sweet spots located at all quadrants for each wood type. Still further, the vibration values and COR measurement values may be quantified for other locations along the bat barrel, outside the designated sweet spots. According to one example, the vibration values and the COR measurement values may be recorded by the computer 202 and subsequently marked on the bat 201. For example, the bat barrel or bat knob may be marked with selected vibration values and COR measurement values. According to another example, the computer 202 may monitor, measure, record, and/or display a vibration magnitude value and/or a COR measurement value detected at several points of interest along a circumference of the bat barrel to determine a desired barrel hitting area irrespective of whether the point of interest falls within a conventional edge grain area or face grain area. In other words, the desired barrel hitting area may fall within a blend of the edge grain area and/or the face grain area.

According to one example, a hitter may review the bat markings and elect to hit a baseball with a barrel area located in a quadrant having the lowest vibration value or the highest COR measurement value. Alternatively, the hitter may elect to hit a baseball with a barrel area located in a quadrant having a blend of a low vibration value and a high COR measurement value. According to one example, the barrel area having the lowest vibration value, the highest COR measurement value, or a blend of the two may or may not correspond to the designated sweet spot. According to one example, the barrel area having the lowest vibration value may impart more exit velocity on a baseball. Alternatively, the barrel area having the highest COR measurement value may impart more exit velocity on a baseball. Still further, the barrel area having a blend of a low vibration value and high COR measurement value may impart more exit velocity on a baseball.

With reference to FIG. 2C, the bat support 214 may be opened and the bat clamp 212 may be vertically lifted to reposition the bat 201 within the device 200. For example, the bat may be repositioned to align a desired barrel area, such as a sweet spot, directly in line with a retracted vibration impact device 206. As discussed above, the bat support 214 may include a clamping chuck with gears that are actuated to clamp down on the bat barrel or to open up the bat support 214. According to one example, a handle of the vibration impact device 206 is released to allow the vibration impact tool 218 to strike the bat within the desired barrel area. According to one example, the barrel end of the bat is free to vibrate about the handle when removed from the bat support 214. According to one example, the vibration sensor 225 is mounted proximate to the bat clamping device 212 and may be in contact with the bat 201 to detect vibrations at the bat handle. According to one example, the vibration sensor 225 measures a vibration magnitude. According to one example, the computer 202 may record the vibration value. According to one example, a lower vibration magnitude represents less energy lost into the bat 201 from the impact. Accordingly, a lower vibration magnitude result in more energy transferred into the baseball instead of being lost into the bat 201 during the bat/ball collision. According to one example, the device 200 may be employed to effectively determine how “sweet” a sweet spot is for a bat 201.

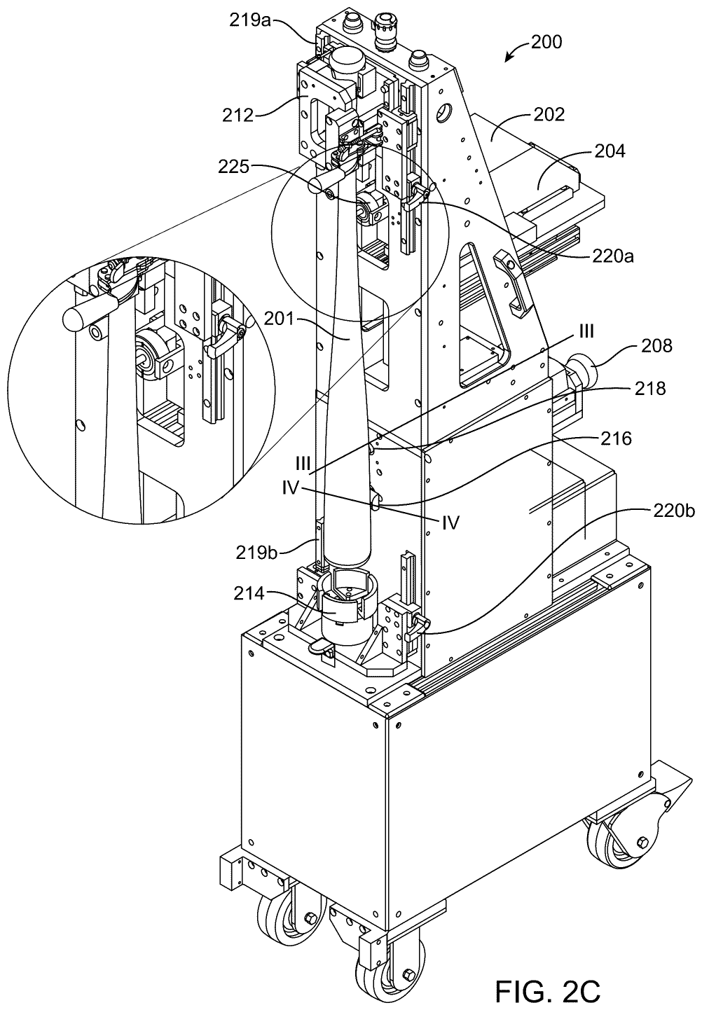

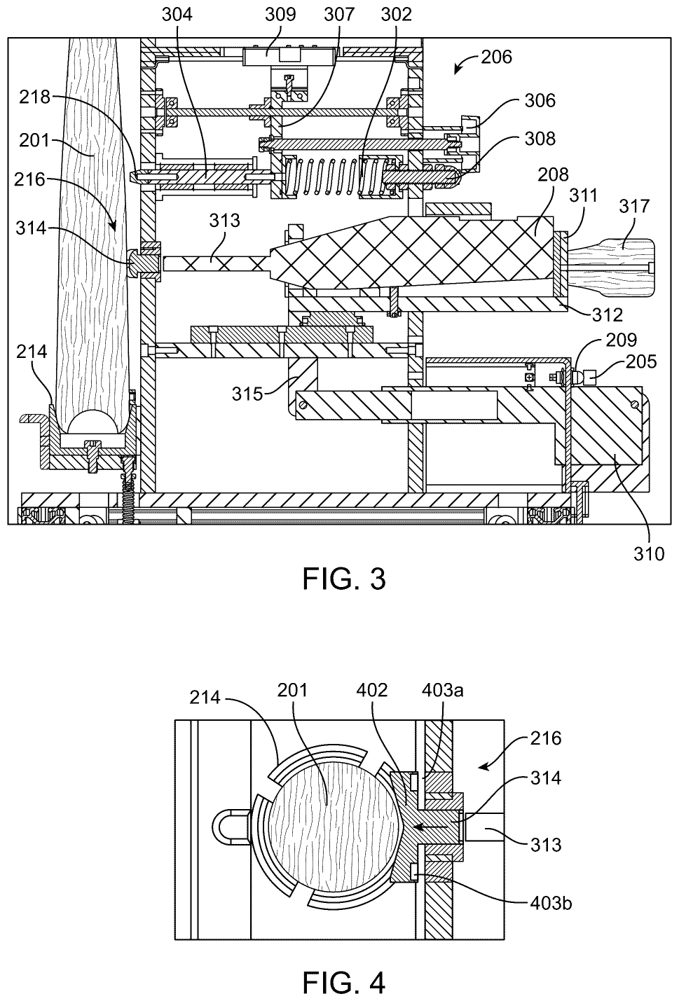

FIG. 4 illustrates a cross-sectional view of the force dispersion tool 216 taken along line IV-IV of FIG. 2B according to one example of the technology. According to one example, the force dispersion tool 216 includes a guide rod 314, a contact area 402, and magnets 403a-b (hereinafter 403). According to one example, an arrow extending between the plunger 313 and the contact area 402 illustrates that the plunger 313 may contact a center portion of the guide rod 314 to direct the impact force toward a center-line 502 as illustrated in FIG. 5. According to one example, the force dispersion tool 216 transfers an impact force of the plunger 313 onto the bat 201.

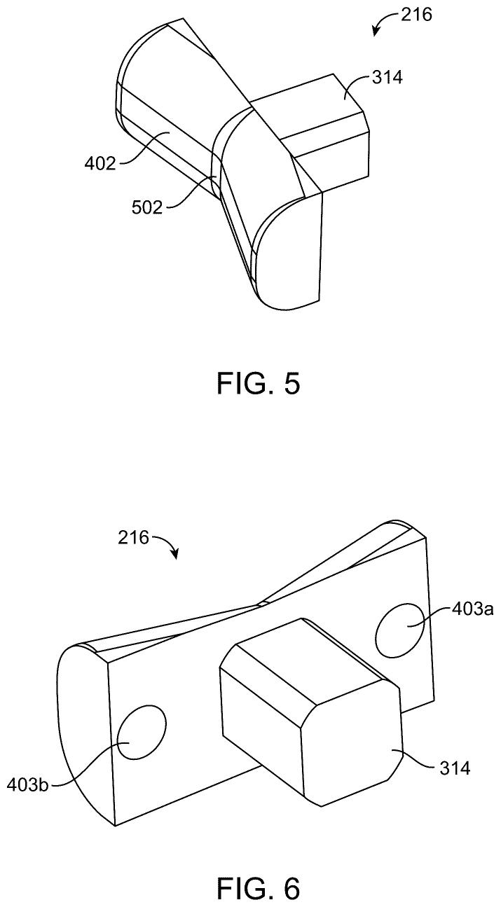

FIGS. 5 and 6 illustrate structural details of the force dispersing tool 216 according to one example of the technology. According to one example, the force dispersing tool 216 may include a custom contact area 402 that transfers the impact force received through the guide rod 314 onto the bat 201. According to one example, the force dispersing tool 216 may be constructed from hardened tool steel or the like. According to one example, the contact area 402 distributes the impact force over a larger surface area compared to a surface area at the end of the plunger 313. According to one example, spreading the impact force over a larger surface area avoids marking or indenting a surface of the bat 201. According to one example, the contact area 402 transfers the impact force received through the guide rode 314 onto two locations on both sides of a center-line 502. With reference to FIG. 4, the force dispersing tool 216 is held in the device 200 and may move freely within a machined bushing (not shown) to minimize friction. According to one example, the bushing has a square-shaped geometry to prevent the force dispersing tool 216 from rotating therein. In other words, the bushing is shaped to maintain a consistent alignment with the force dispersing tool 216. According to one example, magnets 403 may be embedded in the force dispersing tool 216. According to one example, the magnets 403 prevent the force dispersing tool 216 from falling out of the device 200 when not engaged with a bat 201.

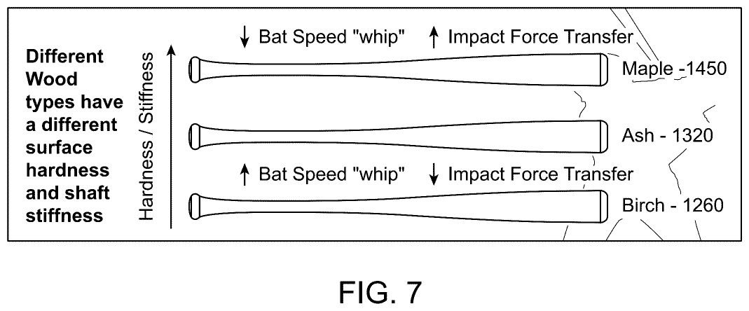

FIG. 7 illustrates baseball bats made from different wood types such as birch, ash, and maple that may have different compressive “rebound” strengths, hardness, and vibration values. With respect to hardness, bats made from softer wood such as birch may transfer less impact force when striking a baseball. In contrast, bats made from harder wood such as maple may transfer more impact force when striking a baseball. Generally, baseballs travel further when hit with bats having higher strike or impact forces.

From the foregoing it will be appreciated that, although specific examples are described herein for purposes of illustration, various modifications may be made without deviating from the spirit and scope of this disclosure. The methods, techniques, and systems described herein for performing vibration testing and the COR value testing on baseball bats are applicable to other settings. Accordingly, the scope of the invention is not limited by the disclosure of the preferred examples herein.

What is claimed is:

1. A device that measures an internal structural integrity and surface hardness of baseball bats, comprising:
a bat clamp that secures the baseball bat at a handle end;
a bat support that secures the baseball bat at a barrel end; and
a rebound hammer that impacts the baseball bat to determine a coefficient of restitution value.

2. The device according to claim 1, further comprising a force dispersing tool coupled to the rebound hammer to directly impact the baseball bat.

3. The device according to claim 1, wherein the bat support is a lathe chuck that applies a clamping force on the barrel end.

4. The device according to claim 1, further comprising a motor that spins the lathe chuck to spin the baseball bat about a lengthwise axis.

5. The device according to claim 4, wherein the motor spins the lathe chuck by a pre-determined increment.

6. The device according to claim 1, wherein the bat clamp includes bearings that allow the baseball bat to spin therein.

7. The device according to claim 1, further comprising linear bearings coupled to the bat clamp and the bat support to enable vertical positioning of the baseball bat relative to the rebound hammer.

8. The device according to claim 1, further comprising a computer that obtains a rebound strength value from the rebound hammer.

9. The device according to claim 8, further comprising a printer electrically coupled to the computer to print labels with the corresponding rebound strength value.

10. The device according to claim 1, further comprising a control panel that mechanically actuates the rebound hammer.

11. A device that measures vibration propagation within baseball bats, comprising:
a bat clamp that secures the baseball bat at a handle end;
a vibration sensor provided proximate to the handle end; and
a vibration impact tool that impacts the baseball bat to transfer a force thereto.

12. The device according to claim 11, wherein the bat clamp applies a clamping force on the handle end.

13. The device according to claim 11, further comprising a motor that spins the bat clamp to spin the baseball bat about a lengthwise axis.

14. The device according to claim 13, wherein the motor spins the bat clamp by a pre-determined increment.

15. The device according to claim 11, further comprising a linear bearing coupled to the bat clamp to enable vertical positioning of the baseball bat relative to the vibration impact tool.

16. The device according to claim 11, wherein the vibration sensor is a piezoelectric sensor.

17. The device according to claim 11, further comprising a computer that obtains a vibration propagation value from the vibration sensor.

18. The device according to claim 11, further comprising a printer electrically coupled to the computer to print labels with the corresponding vibration propagation value.

19. The device according to claim 11, further comprising a control panel that mechanically actuates the vibration impact tool.

20. The device according to claim 11, wherein the vibration impact tool is actuated by one of an electric solenoid or a mechanical spring.
